(19) United States
(12) Patent Application Publication
(10) Pub. No.: US 2026/0242246 A1
(43) Pub. Date: Aug. 20, 2026

(54) A GEOTHERMAL HYDROGEN PRODUCTION AND COMPRESSION SYSTEM

(71) Applicant: GOOD WATER ENERGY LTD, Claremont, Western Australia (AU)

(72) Inventor: Warren Ross STRANGE, Claremont, Western Australia (AU)

(21) Appl. No.: 19/164,360

(22) PCT Filed: Mar. 15, 2024
(86) PCT No.: PCT/AU2024/050232

§ 371 Date: Sep. 11, 2025

(30) Foreign Application Priority Data
Mar. 15, 2023 (AU) 2023900697
Jun. 23, 2023 (AU) 2023901987
Aug. 30, 2023 (AU) 2023902786

(51) Int. Cl. C02F 1/04; B01D 1/00; B01D 1/26; B01D 3/14; C02F 103/08; C25B 9/00; F03G 4/00; F24T 10/10; F24T 10/40; F24T 50/00

(52) U.S. Cl. CPC C02F 1/04; B01D 1/0011; B01D 1/26; B01D 3/146; C25B 9/00; F03G 4/00; F24T 10/10; F24T 10/40; F24T 50/00; C02F 2103/08; C02F 2201/009

(57) ABSTRACT

The present disclosure is directed to a geothermal hydrogen production and compression system, wherein the system comprises an impure water intake to receive water from a impure water source, at least one geothermal well having a well inlet to receive the impure water from the impure water intake in to the geothermal well and one or more well outlets adapted to return heated impure water from the geothermal well, one or more well outlets being adapted to direct the heated impure water from the geothermal well through a steam engine providing a mechanical output, a purification plant comprising one or more purification chambers for separating impurities from the heated impure water expelled from the steam engine to produce at least some fresh water, one or more discharge outlets to discharge one or more products of the purification plant wherein the fresh water is directed to an electrolyser for electrolysis to produce hydrogen gas, where the hydrogen gas is passed through a hydrogen compressor coupled to the mechanical output and pressurised in a storage apparatus.

### CROSS-REFERENCE TO RELATED APPLICATIONS

This application is the National Stage filing under 35 U.S.C. 371 of International Application No. PCT/AU2024/050232, filed Mar. 15, 2024, which claims the benefit of earlier filing date and right of priority to Australian Application No. 2023900697, filed Mar. 15, 2023, Australian Application No. 2023901987, filed Jun. 23, 2023, and Australian Application No. 2023902786, filed Aug. 30, 2023, the contents of which are all hereby incorporated by reference herein in their entirety.

### FIELD

The disclosure is broadly directed to a geothermal hydrogen sequestration system. In particular embodiments, the disclosure provides a geothermal desalination, energy production, hydrogen production and hydrogen compression system.

### BACKGROUND

There exists a considerable demand for the production and subsequent compression of hydrogen into suitable storage apparatus for various purposes. Currently, the major uses of hydrogen include in fuel cells, hydrogen powered vehicles and rocket fuels. Several Government agencies across the world are evaluating the use of hydrogen to replace natural gas at natural gas-fired power plants.

As it stands, hydrogen is currently produced commercially via steam-methane reforming and electrolysis. The former includes the burning of fossil fuels and biomass, whereas electrolysis relies significantly on electricity from natural gas-fired power plants.

These processes for production of hydrogen have significant power requirements, especially when coupled with power requirements for the powering of a compression system to compress the hydrogen into high-pressure cylinders or liquid storage.

People are becoming more environmentally aware, and are seeking greener processes and products, without sacrificing finite resources to produce the same. In many of these hydrogen production, compression and storage systems there are still significant waste products which make the environment benefit of hydrogen use negligible with respect to the work required to obtain it.

In contrast, geothermal energy can provide limitless, zero-emission, baseload renewable energy, but drilling costs have historically made it expensive to do so, and restricted its use to locations where high temperatures are at shallow depth. People typically link geothermal power to countries such as New Zealand, Indonesia and the Philippines which are geologically active and where drilling to 2000 metres or less is sufficient to provide access to the high temperatures required to produce usable energy. However, it would be desirable to drawn on geothermal energy to produce, compress and thereby store hydrogen.

Previous attempts at large scale geothermal energy development in Australia and other countries such as the USA have been thwarted by high drilling costs and both technological and environmental problems using conventional oil and gas drilling techniques. However, the ability to harness deep thermal heat and to utilise this energy to provide low cost electricity generation as well as hydrogen production and compression, without the need or use of electricity, is highly desirable.

Zero-emission electricity and distilled water can be used to produce ‘green’ hydrogen, at lower costs than solar/battery produced green hydrogen. Green hydrogen is a desirable fuel and a potential clean energy storage solution of the future.

The present disclosure was conceived with these shortcomings in mind.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

### SUMMARY

In a first aspect of the present disclosure there is provided a geothermal hydrogen production and compression system, wherein the system comprises an impure water intake to receive water from a impure water source, at least one geothermal well having a well inlet to receive the impure water from the impure water intake in to the geothermal well(s) and one or more well outlets adapted to return heated impure water from the geothermal well(s), one or more well outlets being adapted to direct the heated impure water from the geothermal well through a steam engine providing a mechanical output, a purification plant comprising one or more purification chambers for separating impurities from the heated impure water expelled from the steam engine to produce at least some fresh water, one or more discharge outlets to discharge one or more products of the purification plant wherein the fresh water is directed to an electrolyser for electrolysis to produce hydrogen gas, where the hydrogen gas is passed through a hydrogen compressor coupled to the mechanical output and pressurised in a storage apparatus.

The thermal syphoning effect in the first embodiment may be provided by having a well bore extending downwardly from a ground surface to define a plurality of substantially vertical bore sections, the first well bore intersecting with the vertical bore sections of each of the remaining wells to fluidly connect each well of the system such that the fluid medium at a first temperature is introduced into the injection well(s) and the fluid medium at a second temperature is drawn from a plurality of production wells or the geothermal well(s) outlet(s).

In some embodiments, the geothermal well inlet and the geothermal well outlet are coupled in a single geothermal well.

It may be advantageous in some embodiments to have the geothermal well inlet and the geothermal well outlet coupled in a single geothermal well, especially in areas where the spacing between the geothermal well(s) is sparse, or wherein the geothermal hydrogen production and compression system is situated on an offshore platform or berth, where having a multi-well system on the sea bed is both expensive or challenging.

In some embodiments, the impure water is salt water.

In some embodiments, the purification plant is a desalination plant.

In other embodiments, the flow of the impure water in the system is sustained by a thermal syphoning effect of the geothermal well, drawing impure water into an inlet of the geothermal well(s) at a first temperature as heated impure water is forced out of a well outlet of the geothermal well(s) at a second temperature, greater than the first temperature.

In some embodiments, the one or more discharge outlets comprise at least one fresh water outlet to discharge the fresh water.

The fresh water which is not used for hydrogen production and subsequent compression may be outsourced to either a fresh water storage apparatus, bottled and supplied to a remote area or captured and shipped back to a mains water supply. It may be an advantage to have fresh water as a side-product of the geothermal hydrogen production and compression system as this net zero emission purification process may serve to not only be a means of hydrogen production, but also as a means of supplying water to a mains system where fresh water is scarce.

In some embodiments, the system may comprise a saline return for a saline output from the desalination plant, and the one or more discharge outlets comprise a salt water discharge to return the saline output to a salt water source.

In other embodiments, the system may comprise a heat exchanger to heat the salt water from the salt water intake and cool the discharge products from the purification plant, prior to discharge of the saline output to the salt water source.

In some embodiments, the system may comprise a start-up pump to initiate flow of the salt water through the geothermal hydrogen production and compression system.

In some embodiments, the start-up pump is a hydrogen powered pump.

In some embodiments, the hydrogen powered pump is powered by a hydrogen fuel cell.

In embodiments of the disclosure, the system is an onshore geothermal hydrogen production and compression system.

Alternatively, the system may be an offshore geothermal hydrogen production and compression system.

In some embodiments, the at least one of the geothermal well(s) reaches surrounding geology of between 300 and 425 degrees Celsius.

In embodiments of the disclosure, the temperature of the heated impure water exiting the geothermal well is between 250 and 350 degrees Celsius.

In some embodiments, the geothermal well(s) may reach surrounding geology of greater than 300 degrees Celsius, and preferably up to 500 degrees Celsius.

In some embodiments, the temperature of the heated impure water is between 120 and 190 degrees Celsius when it enters the steam engine.

In some embodiments, the steam engine's mechanical output is supplemented with a heat recovery turbine.

In some embodiments, the temperature of the heated impure water is between 50 and 120 degrees Celsius when it enters the first of the one or more purification chambers.

In other embodiments, there is provided a power plant to generate electricity from thermal energy of the heated impure water.

In some embodiments, the electrolysis apparatus is driven by electricity produced by the power plant.

In some embodiments, the system is pump free other than optionally a start-up pump.

The start-up pump is generally not required after the system is started due to the thermal syphoning effect explained within. In some cases, there may be a deliberate energy imbalance somewhere in the system such that start-up pumps are not required at all. This may be advantageous when providing a geothermal hydrogen production and compression system which requires net zero input of energy, and which can yield the benefit of running entirely on the thermal syphoning effect which obtains and converts thermal energy into useful work or energy.

Various features, aspects, and advantages of the disclosure will become more apparent from the following description of embodiments of the disclosure, along with the accompanying drawings in which like numerals represent like components.

### BRIEF DESCRIPTION OF THE DRAWINGS

Embodiments of the disclosure are illustrated by way of example, and not by way of limitation, with reference to the accompanying drawings, which are briefly described below.

FIG. 1 is a schematic view of a geothermal hydrogen production and compression system according to an embodiment of the present disclosure.

FIG. 2 is a schematic view of a geothermal hydrogen production and compression system according to another embodiment of the disclosure.

FIG. 3A is a cross-sectional view of a well head of a geothermal well, according to an embodiment where the geothermal well inlet and the geothermal well outlet are coupled in a single geothermal well.

FIG. 3B is a cross-sectional view of a well head of the geothermal well of FIG. 3A, illustrating a series of valves and seals for controlling the flow of liquid into and out of the geothermal well, according to an embodiment where the geothermal well inlet and the geothermal well outlet are coupled in a single geothermal well.

FIG. 4 is a schematic view of the multi-well geothermal syphoning system adapted from FIG. 1 and FIG. 2, according to an embodiment of the disclosure comprising one central injection well and four production wells.

Embodiments will now be described more fully hereinafter with reference to the accompanying drawings, in which various embodiments, although not the only possible embodiments, of the disclosure are shown. The disclosure may be embodied in many different forms and should not be construed as being limited to the embodiments described below.

### DETAILED DESCRIPTION

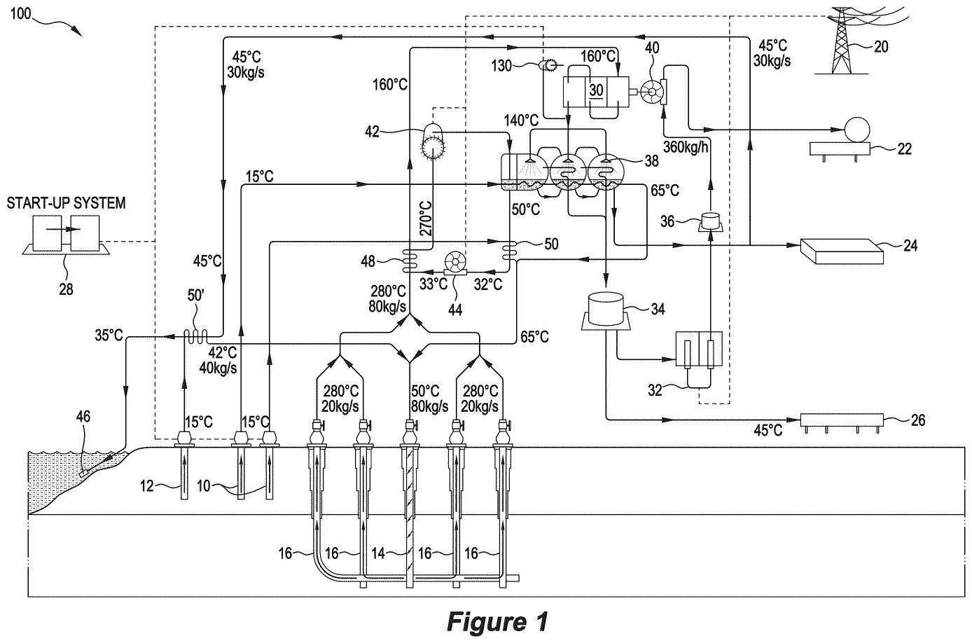

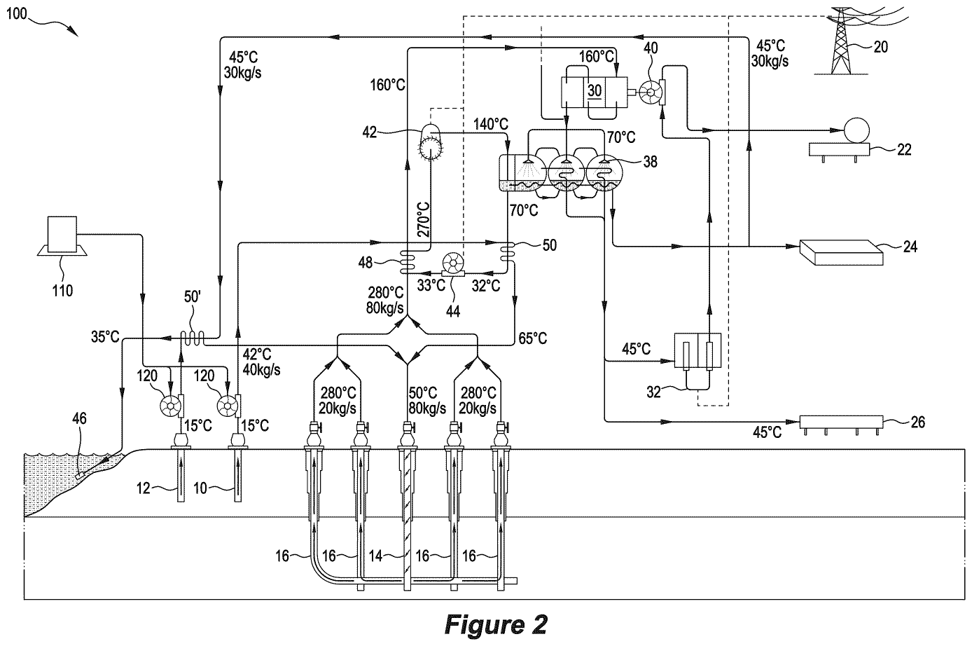

With reference to FIGS. 1 and 2, there is illustrated a schematic view of a geothermal hydrogen production and compression system (100) according to an embodiment of the present disclosure. In this embodiment, the liquid pathway is adapted for use with salt water obtained by a beach well bore (10, 12) which forms the intake. It will be appreciated by those skilled in the art that whilst this embodiment is depicted using salt water from the sea as a impure water source, that the same embodiment can be readily adapted in another setting as fit, for example, on the bank of a river, lake, catchment or basin. The liquid pathway comprises a salt water intake (10, 12) to draw in sea water.

The sea water is then passed through a heat exchanger (50) to at least one geothermal well (14). Whilst this embodiment depicts a multi-well geothermal system, with one injection well (14) and multiple production wells (16), it will be appreciated that the application of the present disclosure is not limited to a specific well arrangement. Embodiments may be provided, for example, with a single geothermal well with one well inlet leading to a downward injection passage of the well, and one well outlet from an upward production/return passage—i.e. where the well inlet and well outlet are coupled in the same well head of a single geothermal well.

In the embodiment shown in FIG. 1, the five geothermal wells (14, 16) are drilled to a depth of approximately 8,000 metres, and spaced approximately 50 metres apart. Each well has a well head (18) adapted to allow inlet and/or outlet of the water, as appropriate.

Once the sea water is passed through to the geothermal well (14), it is heated by the surrounding geology, which may be around 380 degrees Celsius at the bottom of the well (a depth of around 8,000 metres). Of course, it will be appreciated that different geological locations may have different temperature profiles. Once heated, the sea water subsequently flows by thermal syphoning effect up through production wells (16) to their geothermal well outlets of production wells (16) (as shown in the embodiment FIG. 1) to a steam engine (30), cooling slightly through an Organic Rankin Cycle (ORC) heat exchanger (48) en route.

The steam engine receives heated sea water at about 120 to 180 degrees Celsius, converting the thermal energy from the heated sea water into a mechanical output. The heated sea water is then expelled from the steam engine (30) to the purification plant (38). It will be appreciated to those skilled in the art that the purification plant (38) depicted in this embodiment is a desalination plant and will be described as such herein for convenience, although the present disclosure is not limited to desalination. In an equivalent embodiment located on a bank of a river, lake, catchment or basin, or similar, to take in impure water therefrom, it will be appreciated that the purification plant may achieve a similar result to that of the desalination plant, but by way of removing minerals, bacteria, impurities and viruses from the impure water as it proceeds through the geothermal hydrogen production and compression system.

The fresh water is then directed to fresh water storage (34). The impure and saline water from the purification and/or desalination process is directed back to either the geothermal well (14) for recycling, a salt evaporation pond (24) or back to the sea via the discharge pipe (46). It will be appreciated that the salt evaporation pond (24) may be adapted as necessary to isolate minerals and other substances of interest from river water, lake water or similar.

When the impure and saline water from the purification process is directed back to the sea via the discharge pipe (46), it does so via a heat exchanger (50′) coupled to one or more of the beach well bores (12). As depicted in FIG. 1, some of the beach well bores (12), especially those denoted (12) contain a heat exchanger system (50′) for taking heat out of the discharge, whilst heating up sea water from the salt water intake (12). This serves the purpose of heating the sea water for optimum functioning of the geothermal well (14), but also to cool the saline water from 45 to 70 degrees to about 35 degrees Celsius, for minimal environmental impact when it is discharged via seawater discharge (46).

The fresh water in the fresh water storage (34) can be directed to a fresh water outlet (26) for supply into a town, area or for communal water supply more generally. The fresh water in this embodiment is primarily redirected to hydrogen electrolysis apparatus (32) to produce hydrogen from the fresh water obtained from the purification plant (38) via the fresh water storage (34). The electrolysis may be accomplished using electricity generated by the geothermal power plant (20), driven using thermal energy extracted from the heated sea water delivered to the surface under pressure by thermal syphoning effect, from the geothermal well (14).

Hydrogen gas, as product of the electrolysis procedure is directed to low pressure storage (36) before being processed through a hydrogen compressor (40). The hydrogen compressor (40) is coupled and operated by the mechanical output of the steam engine (30). The compressed hydrogen output by the hydrogen compressor (40) is then stored in appropriate hydrogen storage apparatus (22).

The steam engine (30) performs mechanical work using steam from the heated impure water as its working fluid. The steam engine uses the force produced by steam pressure to push a piston back and forth inside a cylinder. This pushing force is transformed, in one embodiment, by connecting a rod and crank into rotation force for working the hydrogen compressor. A person skilled in the art will appreciate that the steam engine could also be of the turbine type. Steam turbines are generally used in high power applications, and use a number of rotating disks containing propeller-like blades at their outer edge. These moving ‘rotor’ disks alternate with stationary ‘stator’ blade rings are affixed to the turbine case that serve a primary purpose of redirecting the steam flow for the next stage. Steam turbines may be advantageous in this embodiment, as they produce smoother rotational forces on their output shaft, which can serve a purpose to reduce the overall wear on the system as a whole. The steam turbine can be coupled to a hydrogen compressor (40) of both the positive displacement type and the centrifugal compression type.

By way of a non-limiting example, the hydrogen compressor (40) may be of the positive displacement type. A positive displacement compressor (PDC) generally comprises at least a reciprocating piston, in which the gas is drawn in during the suction stroke of the piston, compressed by decreasing the volume of the gas by moving the piston in the opposite direction, and thereby discharged when the gas pressure exceeds the pressure acting on the outlet valve. Alternatively, the hydrogen compressor (40) may be a centrifugal compressor. Centrifugal compressors rotate a turbine, which may be driven by the output shaft of the steam turbine, at a high speed to compress the gas. The compressor must operate at speeds 3 times faster than those used for natural gas due to achieve the same compression ratio because of the low molecular weight of hydrogen.

In another embodiment, the steam engine (30) is a standard pushing force steam engine, coupled to a hydrogen compressor (40) of the positive displacement type.

In another embodiment, the steam engine (30) is a turbine type, coupled to a hydrogen compressor (40) which is a centrifugal compressor. This particular embodiment is suited to higher compression requirements due to the sheer output of work that can be gained from the steam turbine.

Referring still to FIG. 1, the compressed hydrogen is then stored in suitable hydrogen storage apparatus (22). The most common hydrogen storage apparatus (22) is a high-pressure gas cylinder. These cylinders generally have a theoretical maximum pressure of 20 MPa. Hydrogen can be compressed into these cylinders in a process known as isothermal compression, in pressures from 0.1 MPa to 80 MPa, consuming ~2.2 kWh/kg of work. This type of output can be obtained using mechanical output or work provided by the coupled steam engine (30).

In yet another embodiment of the present disclosure, the hydrogen storage apparatus (22) may be a liquid hydrogen storage tank. Due to the low critical temperature of hydrogen (33 K), liquid hydrogen can only be stored in open systems, because there is no liquid phase existing above the critical temperature.

Referring to FIG. 1 and FIG. 2, an Organic Rankin Cycle (ORC) electricity generation plant (42, 44) is incorporated into the sea water thermal syphoning energy system. The ORC turbine (DC generator) (42) and ORC pump (44) can be used for electricity generation and sea water desalination without the requirement for external sources of electricity to pump sea water or fresh water. This embodiment of the disclosure therefore includes an N-pentane circuit (42, 44). N-pentane has a lower boiling point than water and is more suitable fluid or gas contained in a separate or secondary ORC circuit that is heated by the hot sea water at temperatures of 280 degrees C. and lower that is flowing from one or more geothermal wells under pressure due to the thermal syphoning effect. The purification plant (38) serves as a cooler and condenser for the ORC circuit gas after it is exhausted from the turbine. The ORC gas is converted to a cooler liquid and then as a liquid, the N-pentane is then heated and turned to a gas state by the heat exchanger that is heated by the geothermal well circuit.

Whilst FIG. 1 of geothermal hydrogen production and compression system (100) is functionally similar to FIG. 2, there are some differences which have the function of improving certain parts of the disclosure, and thus comprise slightly differing embodiments. The embodiment depicted in FIG. 1 employs hydrogen storage coupled to a HFC generator (28) to provide power to the beach well bores to start-up the system. It is important to note that once the system is started, the thermal syphoning effect will keep the circuit going without constant supply from the start-up pumps. The HFC generator (28) in FIG. 1 may be used in the start-up process in order to power the supply of impure water, or in this embodiment, sea water to the head of the geothermal well (14) and well inlet. Once this process is started and the water is heated and expelled via the geothermal well outlet(s) (16), the HFC generator (28) can be powered off. The HFC generator (28) of FIG. 1 can be powered from an external power source initially.

In comparison, and referring now to FIG. 2, is a hydrogen supply and storage (110) which has the primary purpose of providing hydrogen to the hydrogen powered start up pumps (120) situated on the beach well bores (10, 12). This is an alternative to the HFC generator used in FIG. 1, as it does not require any external power source in order to facilitate the start-up process. Similarly, however, once the system is started up, the hydrogen powered pumps (120) can be turned off by restricting the supply of hydrogen from the supply and storage (110), the system and circuit sustaining itself on the thermal syphoning effect.

In another embodiment the thermal syphoning effect will maintain circulation of the liquid. Accordingly, in some embodiments, the geothermal desalination system may be substantially free from pumps, with the likely exception of an electric or thermal energy driven start-up pump which can be used to initiate flow of liquid in the liquid pathway, before the thermal syphoning effect provides 100% of the pumping requirements for sea water intake, sea water discharge and fresh-water delivery. Once the thermal syphoning process begins there is little to no further requirement for pumping (i.e. zero to negligible energy input to keep the system running). Within a few minutes, the start-up pump can be turned off as the thermal syphoning effect will generate the flow and thermal energy production.

Optionally, as depicted in the embodiment of FIG. 1, a heat recovery turbine (130) is installed on the exit of the steam engine (30), where thermal energy can be extracted to power pumps and/or the hydrogen compressor (40). For example, as shown in FIG. 2, the mechanical output of the steam engine may be replace or supplemented via a heat recovery turbine (130), thus reducing the reliance on the steam engine (30). Alternatively, the heat recovery turbine (130) may be used to assist with the thermal syphoning effect to draw sea water, to pump sea water returns or to pump fresh water after the purification process.

It will be appreciated that the embodiment 100 depicted in both FIG. 1 and FIG. 2 still does not require external energy sources, such as external electricity, to drive the pumps, as these can be driven using the thermal energy from the geothermal wells. Albeit the HFC generator (28) in FIG. 1 which may use external energy in some circumstances to facilitate the start-up process.

The benefit of this sea water thermal syphoning desalination system (or adapted to be an impure water purification system) is there is no requirement for external energy sources such as electricity, required for any pumping requirements. Accordingly, the embodiment 100 of FIG. 1 and FIG. 2 provides a low cost alternative to existing fossil fuel, solar, wind, hydro or nuclear energy generated electric driven RO or MED desalination and/or purification processes

Further details in relation to each of the individual features of the disclosure are described below.

### Salt Water Intake

The beach well bores (10, 12) may be any suitable opening to receive salt water while filtering any contamination or sea life. The beach well bores (10, 12) each comprise a beach well head as depicted in FIG. 1. The salt water received by the salt water intake is preferably cold, and in many embodiments will be sea water. Although the salt water intake and beach water bores (10, 12) are primarily described with reference to sea water, and the sea is likely to be most commonly used water source, other sources of salt water may also be used (e.g. reservoirs or salt lakes).

The depth of the beach well may vary, but in some embodiments the beach well may be 20 to 150 metres deep. Beach wells are the preferred method of drawing sea water to a land based desalination plant, as the sea water is filtered by the sands and sediment as it is drawn by the thermal syphoning effect into the geothermal wells and the sea water being drawn from below the surface and low tide level will be cooler than sea water on the surface.

The temperature of the salt water may vary depending on the depth of the salt water intake (10, 12) in the sea, and the geographical location of the geothermal desalination system. For example, water taken from deeper in the ocean will typically be colder than water taken from a shallower location. Similarly, sea temperatures may vary depending on geographical locations and seasons. Similar variations are possible in the salt content of the salt water.

Embodiments with one or multiple salt water intakes or bores are also possible, within the scope of the present disclosure. Multiple geothermal wells may be connected at the bottom of the wells by turning one well and then intersecting the horizontal section of the turned or steered well with one to four additional vertical wells, substantially as described in for example PCT/AU2022/050864 by the same inventor, the entire contents of which are hereby incorporated by reference.

Embodiments with one or more geothermal wells having a well inlet to receive salt water from the salt water intake into the geothermal well(s) and a well outlet via insulated production casing in a single well system or multiple production wells connected to the inlet well at the bottom of the wells, to return heated salt water from the geothermal well or wells are also envisaged, substantially as described in for example Australian Provisional Patent Application No. 2023900697 and 2023901987 by the same inventor, the entire contents of which are incorporated by reference.

### Heat Exchangers

The heat exchangers (50, 50′) serve to heat salt or sea water from the salt water intake (10,12) prior to entry into the geothermal well (14), and also to cool salt water in the saline return prior to discharge into the sea via seawater discharge (46). Reducing the temperature of the sea water discharge is preferred to reduce any impact that the hot sea water discharge may have on the marine environment. Increasing the temperature of the cold sea water intake will also improve the life and efficiency of the geothermal well system. A preferred intake temperature for sea water drawn into the well by thermal syphoning effect is between 50 and 70 degree Celsius.

An advantage of heating salt water to around 50 to 70 degrees Celsius is that it decreases the cooling effect of the colder salt water on the top sections of the geothermal well. If the top sections are cooled too much, this may reduce the temperature of the exiting heated salt water, and affect energy production (in electricity producing embodiments) or the efficiency of the desalination process.

An advantage of decreasing the temperature of the discharged saline water to around 35 degrees Celsius (or preferably between 30 and 40 degrees Celsius) is that it minimises the environmental impact of embodiments of the present disclosure, on the surrounding ecology.

### Geothermal Well

A geothermal well (14) with bottom-hole geology temperatures of about 300 to 500 degrees Celsius, in FIGS. 1 and 2, is used to heat the salt water received via the beach well bore (10, 12) or equivalent impure water intake. The thermal syphoning effect forces geothermally heated water to the surface as cold water is drawn into the well (14) to heat. The heated water from the well (14) is then forced or pushed from the one or more well head outlet(s) (16) under pressure, towards the purification or desalination plant (38). It will be appreciated, as is substantially described and similar to Australian Provisional Patent Application No. 2023900697 and 2023901987 by the same inventor, the entire contents of which are hereby incorporated by reference that the geothermal well may have the well inlet and well outlet coupled within the same geothermal well as described herein.

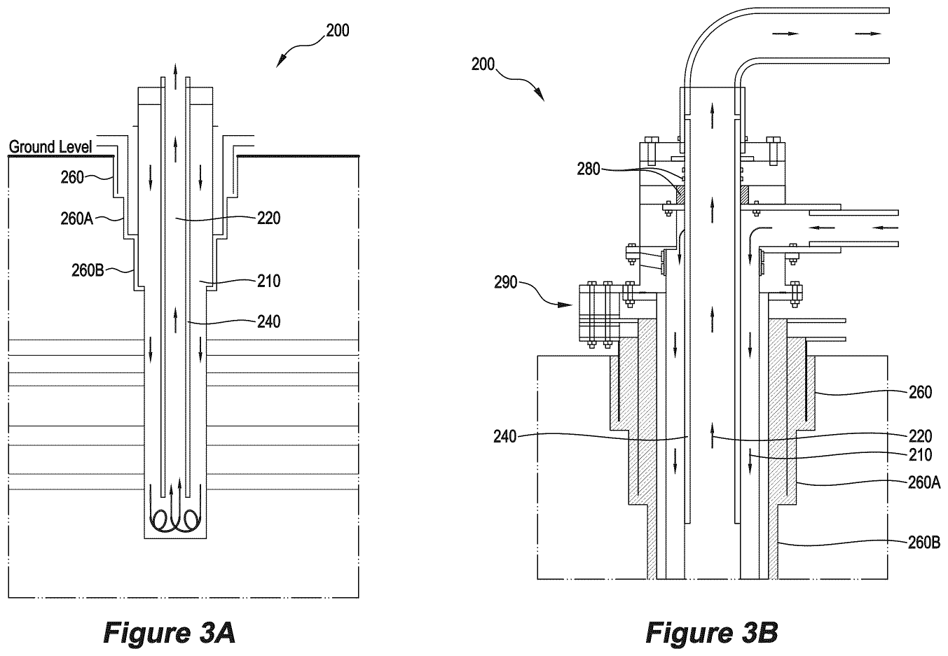

Referring to FIGS. 3A and 3B, the geothermal well in an embodiment may have the well outlet and the well inlet coupled in a single geothermal well. Whilst this is not explicitly depicted when applied to the geothermal hydrogen production and compression system, the person skilled in the art would readily adapt the system from the multi-well system depicted in FIG. 1 or FIG. 2, to a single well system as described in the following paragraph.

A single geothermal well (200) is illustrated in FIG. 3A to provide for circulating liquid through the liquid pathway of the geothermal hydrogen production and compression system (100). It provides an inlet channel (annulus) (210) and insulated return channel (220) for supplying a heated salt water to the well head. The channels (210, 220) are arranged co-axially in tubing strings within the well (200).

Shown in FIG. 3A, the well (200) includes a pipe inlet, a pipe outlet, the inlet channel (210) (first channel) and the insulated return channel (220) (second channel) disposed concentrically within the well 200. Although not illustrated, it is contemplated that the inlet channel (210) could be swapped with the insulated return channel (220) such that the inlet channel (210) is bounded and centrally located within the return channel (220).

The inlet channel (210) extends down the well (200) and receives liquid (i.e. impure water) from the pipe inlet and is defined between an outer casing and an insulated inner casing (240). The insulated return channel (220) is defined by the insulated inner casing (240) positioned within the outer casing. The insulated return channel (220) provides heated salt water to the pipe outlet.

Additional support casings (260, 260A, 260B) can be nested to extend the well downwards with a decreasing diameter. For example, a first support casing (260) may extending from the well head to a depth of around 100 metres, and have a diameter of approximately 30 inches (e.g. 75 to 80 centimetres). A second support casing (260A) may be positioned within, and may abut, the first support casing (260) and may extend from the well head to a depth greater than the first support casing (e.g. 1500 metres). The second support casing (260A) may have a diameter of 18⅝ to 20 inches (e.g. 45 to 55 centimetres). Further cascading support casings (e.g. 260B) may be positioned within the second support casings, to deeper depths and narrower diameters, as desired.

An outer casing (270) is positioned with the support casings (260, 260A, 260B) and defines a bottom of the well (200). The outer casing (270) may have a diameter of 12 to 14.5 inches. The outer casing (270) can be partially defined by the geological layers. In some embodiments the outer casing (270) may be consolidated rock such as granite that contains no groundwater, but has high levels of heat that will transfer into the impure water as it is drawn down the inlet channel (210) and comes into contact with the outer casing (270) of the well (200). A “closed-well” or sealed well arrangement prevents contact between the salt water and the geology surrounding the well (200). This “closed well” arrangement prevents sediment and other geological impurities from entering the liquid pathway of the salt water in the geothermal desalination system.

The outer casing (270) of the well (200) will generally extend axially into the ground, but the depth may vary depending on the desired temperature of the surrounding geology. In some embodiments, the well (200) may extend to a depth of 4,000 to 5,000 metres, where typical geology temperatures (outside volcanic regions) are around 200 to 250 degrees Celsius. The specific depth, and surrounding geology temperature, may be selected by the skilled person to meet the thermal energy requirements of the particular geothermal desalination and/or electricity generation and/or hydrogen generation system.

An expanded view of the well head is shown in FIG. 3B, which may include a plurality of seals (280), an exterior support collar (290), and other features to provide proper support and outlet for of the well (200).

Sustainable production flow from single or multi well geothermal systems at a temperature of 200 degree Celsius and higher, may be used to drive an ORC turbine (42) which in turn drives a DC or AC electricity generator for the generation of electricity which can be transmitted to a mains power grid, or to drive additional functionality of the geothermal desalination/purification system and electricity system (100). For example, the electricity could be used to drive hydrogen electrolysis (32), or could be used to provide power to a power grid (20). For generating electricity, the preferred sustainable production temperature of the heated salt water exiting the geothermal well (16) would typically be between 280 to 300 degrees Celsius for commercial viability or suitable returns on investment. Reliable and sustainable electricity can be generated from well production temperatures as low as 200 degree Celsius with electricity generation costs below $0.03c per kWh and for periods beyond 20 years, however to finance a geothermal electricity generation system with these low levels of production, it would be difficult to attract investors compared to the production levels and investment returns that could be achieved with geothermal production temperatures above 250 degree Celsius. For embodiments in incorporated references where only desalination is required, temperatures of around 110 to 120 degrees Celsius (from a shallower well) would be suitable for very low-cost desalination and suitable returns on investment.

The multi well thermal syphoning system disclosed in the embodiments of FIG. 1 and FIG. 2 (and also disclosed in PCT/AU2022/050864) will provide more efficient and higher production levels than the single well system equipped with insulated production casing as described by incorporated references. The multi-well thermal syphoning system of PCT/AU2022/050864, Australian Provisional Application No. 2021902611 and Australian Provisional Application No. 2021106085 will be described herein, the entire contents of which are hereby incorporated by reference. The single well system is shown in the drawings provided with this patent application to simplify the description and drawings, however in practice, the multi well geothermal syphoning well system will be used to provide higher production levels and stronger returns to investors and shareholders.

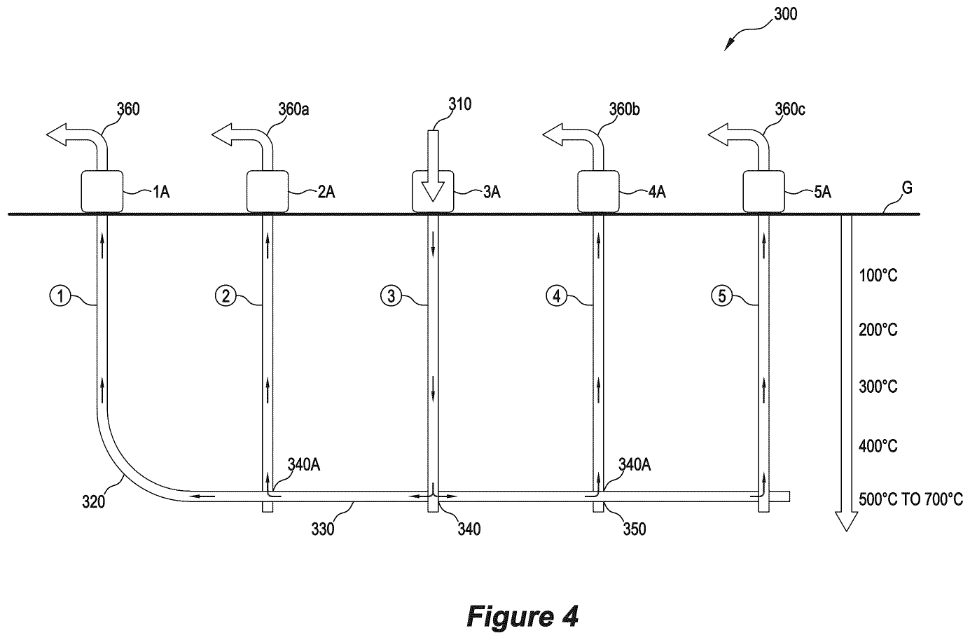

Referring to FIG. 4 the geothermal well(s) of an embodiment of the disclosure may be a multi-well geothermal syphoning system as depicted in the embodiments of FIG. 1 and FIG. 2. A multi-well geothermal syphoning system (300) is described comprising one injection well (3) and four production wells (1, 2, 4, 5), the injection well (3) having an inlet valve (310) for controlling a volume of fluid medium entering the system (300) and each of the four production wells (1, 2, 4, 5) having an outlet valve (360, 360a, 360b, 360c) for controlling the volume of the fluid medium exiting the system (300), each of the wells (1, 2, 3, 4, 5) having a well bore extending downwardly from a ground surface (G) to define a plurality of substantially vertical bore sections, a first well bore comprising a first vertical bore section turning through 90 degrees and extending parallel to the ground surface to thereby define a horizontal bore section (330), the first well bore intersecting with the vertical bore sections of each of the remaining wells (2, 3, 4, 5) to fluidly connect each well (1, 2, 3, 4, 5) of the system (300) such that the fluid medium at a first temperature is introduced into the injection well (3) and the fluid medium at a second temperature is drawn from the four production wells (1, 2, 4, 5).

In FIG. 4, the injection well (3) is illustrated as the central well in the system (300); however, it is contemplated that the injection well can be any well in the system. The system (300) of FIG. 4 illustrates only one injection well (3) however, it is contemplated that multiple injection wells (3) can be incorporated into the system (300).

Each well has a respective well head (1A, 2A, 3A, 4A, 5A) channelling the fluid medium into a system inlet (310) or out of one or more system outlets (360, 360a, 360b, 360c) of the system (300) via the inlet and outlet valves. These valves can be configured as inlet flow control valves and outlet flow control valves (not shown).

The plurality of wells (1, 2, 3, 4, 5) generate movement of the fluid medium along the horizontal bore section (330) of the system (300) in fluid communication with each well of the system (300) to improve transfer of thermal energy between the surrounding geology and the fluid medium within the system (300) and control a flow of the fluid medium through the system (300). The plurality of wells (1,2,3,4,5) are configured in a series of adjacent wells comprising only the single, centrally located injection well (3) for inputting fluid medium into the system (300) and outer four production wells (1,2,4,5) disposed on opposing sides of the central injection well (3).

Drilling to the depths required by either the single geothermal well embodiment or the multi-well embodiment may be effected by drilling technology such as drilling disclosures designed by the present inventor, disclosed in PCT/AU2020/051060 (“Liquid Hammer Drill”) and PCT/AU2021/051105 (“Centre Bypass Mud Hammer”), the entire contents of which are hereby incorporated by reference.

The heated salt water can flow out of the well(s) (16) at a liquid flow rate of between 5 and 20 kg/sec at a temperature between 90 to 300 degrees Celsius, depending on the depth of the geothermal well (14, 16). A deeper well can have a thermal energy output of between 5 MWt-30 MWt, for example 19.78 MWt can be achieved with a flow rate from the well head (32) of 20 Kg/sec and temperature of 280° C. where the initial well injection temperature is 50° C.

The well (14, 16) can be configured for a few thousand metres up to about 12,000 m into almost any geology including granite. The depth of each geothermal well, being limited by the drill rigs capacity to lift the weight of the drill pipe and the temperature of the geology rather than the depth capacity of the CBMH drilling tools. The geothermal heat is exchanged at depth via a closed-loop system rather than bringing deep geothermal brine to the surface. This form of well (14, 16) has a production life of 100+ years, with relatively low maintenance costs. The well (14, 16) has a small physical footprint and has minimal impact on surface ground water systems.

### Offshore Capability

The well (14, 16) of FIG. 1 or FIG. 2 may be adapted to an offshore geothermal hydrogen production and compression system. A person skilled in the art would readily adapt the beach bore wells (10, 12) to sea bed bore wells and the geothermal well inlets (14) and outlets (16) to sea bed adapted geothermal wells to enable this capability. It is envisaged, similar to the offshore system described in Australian Provisional Patent Application No. 2023900697 and 2023901987 by the same inventor, the entire contents of which are hereby incorporated by reference, that all other components may be situated on a berth or ship to enable full offshore capability. In an embodiment, the compressed hydrogen may be able to power a hydrogen powered berth or ship to essentially afford an arrangement which is powered completely on hydrogen.

In another embodiment, most of the components of the geothermal hydrogen production and compression system are supported on an offshore platform, wherein a transport ship is able to dock, collect and transport the compressed hydrogen back to shore, whilst using hydrogen to power the ship thus creating net zero emission hydrogen supply to remote islands, for example.

### Desalination Plant

In the embodiments, a desalination plant (38) is provided to separate salt from the heated salt water. In the embodiment of FIG. 1, heated sea water is passed directly, along the liquid pathway, to the steam engine (30) at a temperature of between 150 and 180 degrees Celsius, to the desalination plant (38) at a temperature of between 75 and 100 degrees Celsius following its use to produce steam in the steam engine (30). The desalination plant (38) contains multiple desalination chambers, including a first desalination chamber and last desalination chamber. The sea water can be sprayed into each chamber of the plant to be desalinated in stages therein.

The disclosed embodiments of the disclosure can use a multi-effect distillation (MED) plant, which uses distillation to desalinate sea or salt water. In each “effect” or “stage” of the multi effect distillation (MED) plant), salt water is sprayed onto tubes or plates made from titanium or stainless steel, heated by thermal energy inside of the tubes or plate heat exchangers that are position inside of the desalination chambers. Some of the saline water evaporates, and this fresh vapour is directed into the next chamber of the MED plant to be sprayed onto the tubes or plates in the next chamber and so on until this process has been replicated-usually between three and seven times, in three to seven desalination chambers of the MED plant with increasing vacuum or decreasing atmosphere pressure in each chamber, heating and evaporating more fresh water from salt water. Thus each stage reuses energy from the previous stage, with successively lower temperatures and pressures. For simplicity, three desalination chambers are shown in each desalination plant (38) depicted in FIGS. 1 to 7. However, different numbers of desalination chambers may be used in different embodiments of the disclosure. The temperature of the sea water usually reduces by 5 degree Celsius as it passes through each chamber. If the temperature of the sea water injected in the first chamber is 75 degree C. after contact with the heat exchanger plate, and there are 7 chambers, the temperature of the fresh water outlet will be 45 degree Celsius.

The MED plant (38) comprises a sequence of closed chambers separated by walls, having a hot fluid or steam heat source at a first chamber the same fluid with reduced heat (condensed) exiting from the first chamber. Each successive chamber has a temperature and a pressure lower than a previous chamber. For example, the temperature may decrease by about 5 degrees Celsius between each desalination chamber. This means the walls within each chamber are held at a temperature intermediate the temperatures of the fluids on either side thereof. This temperature differential, coupled with a pressure drop or increased vacuum in the chamber, transfers evaporation energy from a warmer first zone of the chamber to a colder second zone of the chamber. From the second zone the heat energy then travels via conduction (and/or piping) through the wall to the colder subsequent chamber. Additional salt water can also be sprayed into the subsequent chambers to continue the effect through each chamber of the desalination plant (38).

In the embodiment of FIGS. 1 and 2, the salt water enters the first chamber of the MED plant (38) that has a heat source of about at about 75 degrees Celsius, but the temperature of the vaporised water will be approximately 75 degree C. after coming into contact with the heat plate. In other embodiments, where the salt water is heated to higher temperatures (e.g. 280 degrees Celsius or higher) by the geothermal well, the thermal energy may be used to generate steam for use by the steam engine (30), thereby cooling the salt water to around 75 degrees Celsius before it enters the desalination plant. Variations on these temperatures are possible in different embodiments.

The desalination plant (38) has two main outlets. Firstly, there is a fresh water outlet (34). Secondly, there is a brine outlet, where the brine may be discharged through a saline output for subsequent evaporation in salt evaporation ponds (24), or may be transferred via a sea water return to eventually be returned to the sea via sea water discharge (46). It should be noted that the brine from the desalination plant may also be used for other downstream processes, or harvested for desirable commercial properties. For example, the waste brine can be evaporated in evaporation ponds (24) to produce salt, pot ash, magnesium, lithium and other minerals at very low cost compared to current mining process for these minerals. These products can be sold to farmers for fertilising requirements and to the public for consumption and a wide range of other requirements.

The fresh water may be intermediately stored in a fresh water storage tank (34) or may be directed a pipe line or a collection point for use/collection (26).

It is calculated that for every million litres of salt water delivered to the MED plant (38) approximately 400,000 litres of distilled or fresh water can be produced from fresh-water output (34, 26) without any CO₂ emissions, toxic waste or additional electricity load input and at an operational cost per KL of around 10c per kl. This production cost is approximately 25 times lower than typical RO desalination costs per KL when electricity is used to pump sea water at high pressure through filters and to pump the fresh water away from the plant.

Whist the geothermal desalination plant of the disclosure is described herein in relation to an MED desalination plant, it is contemplated that the disclosure can also be applied to a Reverse Osmosis (RO) desalination plant. The quality of the fresh water will be lower when reverse osmosis filtration is used to desalinate the sea water and plastic waste is generated as the filters are replaced regularly. The preferred method of desalination is MED due to the much higher quality of water, being boiler grade distilled water, that would normally have a production cost above $5.00 per kl when electricity is used for the desalination process.

As described throughout, this system is not limited to sea water. It is envisaged that this disclosure may be readily and easily adapted to other applications, such as on river beds, basins or catchments. Applying the same principles as described, and alternating a desalination plant with a purification plant may provide a method for the purification of lake water, providing fresh water for hydrogen electrolysis. The purification process in a purification plant would be via conventionally available purification apparatus.

The process of purification of impure water from any source may include coagulation and flocculation, sedimentation, filtration by rapid sand filters, bank filtration membrane filtration. Additionally there may be steps including the removal of ions and other dissolved substances and finally, disinfection.

### Hydrogen Production and Compression

As depicted in FIGS. 1 and 2, embodiments of the present disclosure (100) may also be used to generate hydrogen from the fresh water produced by the desalination plant (34).

Fresh water is directed to hydrogen electrolysis apparatus (32) where the water reacts with the anode to form oxygen and hydrogen ions (protons). The electrons flow through an external circuit and the hydrogen ions selectively move across the polymer electrolyte membrane electrolyser (PEM) to the cathode. At the cathode, hydrogen ions combine with electrons from the external circuit to form hydrogen gas. The general chemical formula given to this process is:

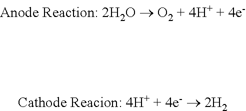

In an embodiment of the present disclosure, the electrolyser is a polymer electrolyte membrane electrolyser, wherein the electrolyte is a solid specialty plastic material. These types of electrolysers are analogous in some respect to a fuel cell, consisting of an anode and a cathode, separated by an electrolyte. Fresh water is directed to hydrogen electrolysis apparatus (32) where the water reacts with the anode to form oxygen and hydrogen ions (protons). The electrons flow through an external circuit and the hydrogen ions selectively move across the PEM to the cathode. At the cathode, hydrogen ions combine with electrons from the external circuit to form hydrogen gas. The general chemical formula given to this process is described in paragraph as above.

In another embodiment of the present disclosure, an Alkaline Water Electrolysis (AWE) apparatus is used to produce hydrogen from the fresh water. AWE electrolysis is a key technology for large-scale hydrogen production powered by renewable energy, however it is a challenge to operate these systems reliably and efficiently when relying on wind or solar.

In said embodiment, the water (electrolyte) may be pumped through the electrolysis stack, where the product gases are formed. While natural convection can be a cost-efficient alternative, gas coverage of the electrode surface can raise the required cell voltage and therefore increase the operational costs. Additionally, alkaline water electrolyser systems either (a) provide temperature for the electrolyte or (b) are required to have the electrolyte passed through the electrolysis stack at a moderately high temperature thereby increasing operational costs and input energy. The heat from the system, or the ORC exchanger may be utilised in an embodiment to heat the water from the desalination process to a temperature of at least 150 degrees Celsius. This may provide yet another advantage over wind and solar options, where the heat would otherwise be wasted.

At the cathode, water molecules are reduced by electrons to hydrogen and negatively charged hydrogen ions. At the anode, hydrogen ions are oxidised to oxygen and water while releasing electrons. Overall, a water molecule reacts to hydrogen and oxygen in the ratio of 2:1 according to the following equation:

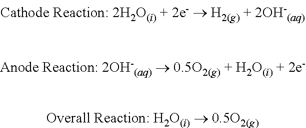

It will be appreciated by those skilled in the art that in an embodiment, such as that depicted in FIG. 1 or any other embodiment discussed throughout that there are significant cost-benefit differences between relying on a PEM electrolyser vs an AWE apparatus and that either may be readily installed in the system and/or circuit. Furthermore, it will be appreciated that it may be a significant advantage of the geothermal hydrogen production and compression system that AWE may be employed wherein in solar and wind based hydrogen production and compression systems, PEM electrolysers may be the only option for water electrolysis due to the following shortcomings.

Firstly, PEM is better suited for renewables where energy supply or flow is not consistent. These are generally higher cost, whereas AWE is lowest cost but requires stable power supply, with excess power, to which at least one embodiment of the geothermal hydrogen and production system possesses. This standby or basal power load may be provided through numerous power storage or green energy sources as discussed in the embodiments.

An AWE electrolyser is estimated to be $A100-200 per kilowatt cheaper than PEM electrolysers. On average, an AWE electrolyser has capital expenditure requirements of 50% of standard PEM electrolysers. Today, a PEM degrades twice as fast as an alkaline electrolyser due to the fragility of the membranes, and harsh environment they are subjected to, being acidic from the concentration of hydrogen ions.

Some AWE electrolysers are capable of operating on 50 kWh of green energy per kilogram of hydrogen, with some of the latest designs operating as low as 35 kWh per kilogram.

In yet another embodiment of the present disclosure, the fresh water derived from a purification plant, such as a desalination plant, may be heated with waste heat produced by the system. An ORC heat exchanger may be installed on the fresh water supply from the purification plant through to the AWE electrolyser to increase the temperature of the input water to 150 degrees Celsius or greater. This may increase the efficiency of the AWE by driving the process of hydrogen production.

A person skilled in the art would appreciate that there are many different embodiments involving heat transfer within the system which may be readily adapted to heat the fresh water before input into the AWE, utilising waste heat from the system.

In an embodiment, the AWE electrolyser is supplied with back up, base load or basal energy from the excess power supply provided to the grid by the geothermal syphoning effect of the multi-well geothermal well arrangement. This can be particularly important when using AWE electrolysers, and may provide another advantage of using a geothermal hydrogen production and compression system, as opposed to wind and solar adaptations which may have a shortcoming of not being capable of providing a stable energy supply to the AWE electrolyser,

In an embodiment, the AWE electrolyser is supplied with back up, base load or basal energy by stored hydrogen and an associated HFC generator.

Following the electrolysis process, hydrogen gas, as product of the electrolysis procedure is directed to low pressure storage (36) before being processed through a hydrogen compressor (40). The hydrogen compressor (40) is coupled and operated by the mechanical output of the steam engine (30). The compressed hydrogen output by the hydrogen compressor (40) is then stored in appropriate hydrogen storage apparatus (22).

In the embodiment in FIG. 1 and FIG. 2, the steam engine (30) provides mechanical output and is therefore coupled to the hydrogen compressor to result in a completely geothermal energy-powered compression and sequestration system for hydrogen capture and compression (for storage).

In another embodiment, the steam engine (30) is a standard pushing force steam engine, coupled to a hydrogen compressor (40) of the positive displacement type.

In another embodiment, the steam engine (30) is a turbine type, coupled to a hydrogen compressor (40) which is a centrifugal compressor. This particular embodiment is suited to higher compression requirements due to the sheer output of work that can be gained from the steam turbine.

### Specific Terminology

The term “well” has been used herein to refer to a deep geothermal wellbore providing thermal energy from hot geology to power the system. For clarity, the term “bore” has been used herein to refer to a salt water wellbore or beach well, providing salt water to the desalination plant. The technical terms bore and well can be used interchangeably, and have been used selectively herein in relation to the geothermal well and the salt water bore, merely for clarity.

While the term “turbine” is used herein to describe a machine that produces mechanical work by passing a fluid flow over a rotor or impeller to impart rotational motion thereto, it is understood that the “turbine” can be substituted for other mechanical devices, such as a steam engine, an Organic Rankine Cycle (ORC) turbine or a screw expander. Those skilled in the art will appreciate that different expanders are suitable for different power ranges and applications.

While the terms “purification plant” and “desalination plant” are used interchangeably throughout, a person skilled in the art will appreciate that a desalination plant is a form of a purification plant, namely, a plant for purifying salt from sea water. No use of either “purification plant” or “desalination plant” should be read in an exclusive sense, such that when the embodiment described in either FIG. 1 or FIG. 2 is applied to salt water or lake water or vice versa, that it excludes the interpretation of either thereof.

Although embodiments of the disclosure have been described with particular reference to the desalination of sea water, it will be understood that different sources of salt water (e.g. above or below ground water bodies, that may be or become hypersaline) are also suitable for desalination. It will also be understood that other embodiments of the disclosure may utilise other liquids, and/or may extract other types of impurities from those liquids.

Although good faith indications of the commercial efficiency of the present disclosure are provided below, these are provided for illustrative purposes, and the figures provided (e.g. the relative costs of desalinated water, or electricity) should not be taken as limiting, or as binding or limiting the present disclosure. The precise commercial utility of any particular embodiment will depend on numerous factors specific to that embodiment of the disclosure, and the commercial circumstances at the time.

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

As used herein and in the appended claims, the singular form of a word includes the plural, unless the context clearly dictates otherwise. Thus, the references “a,” “an” and “the” are generally inclusive of the plurals of the respective terms. For example, reference to “a feature” includes a plurality of such “features.” The term “and/or” used in the context of “X and/or Y” should be interpreted as “X,” or “Y,” or “X and Y.

It is to be understood that, if any prior art publication is referred to herein, such reference does not constitute an admission that the publication forms a part of the common general knowledge in the art, in Australia or any other country.

In the claims which follow and in the preceding description of the disclosure, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the disclosure.

LEGEND

| No. | Description | No. | Description |
|---|---|---|---|
| 100 | Geothermal hydrogen | 48 | ORC Heat exchanger |
| | production and | | |
| | compression system | | |
| 10 | Beach well bore/water | 50 | Heat exchanger for |
| | intake | | incoming sea water |
| 12 | Beach well bore with | 110 | Hydrogen supply and |
| | coupled heat exchanger | | storage for start-up pump |
| 14 | Geothermal well inlet | 120 | Hydrogen powered |
| | | | start-up pump |
| 16 | Geothermal well outlet | 130 | Heat recovery turbine |
| 18 | Well head | 200 | Single geothermal well |
| | | | arrangement |
| 20 | Power plant | 210 | Inlet channel (annulus) |
| 22 | Pressurised hydrogen | 220 | Insulated return channel |
| | storage apparatus | | |
| 24 | Evaporation pond | 240 | Insulated inner casing |
| 26 | Fresh water supply | 260 | Additional support |
| | (external) | 260A/B/C | casings |
| 28 | Hydrogen start-up storage | 270 | Outer casing |
| | and HFC generator | | |
| 30 | Steam engine | 280 | Seals |
| 32 | Hydrogen electrolysis | 290 | Exterior support collar |
| | apparatus | | |
| 34 | Fresh water storage | 300 | Multi-well geothermal |
| | | | syphoning system |
| 36 | Low pressure hydrogen | 310 | Inlet valve |
| | storage | | |
| 38 | Purification plant apparatus | 360 | Outlet valve |
| | | 360a/b/c | |
| 40 | Hydrogen compressor | 320 | 90 degree outlet turn |
| 42 | ORC Turbine | 330 | Horizontal bore system |
| 44 | ORC Pump | 340 | Outlet junction |
| 46 | Discharge pipe | 350 | Heated liquid junction |

1. A geothermal hydrogen production and compression system, wherein the system comprises:
an impure water intake to receive impure water from a impure water source;
at least one geothermal well having a well inlet to receive the impure water from the impure water intake in to the geothermal well(s) and one or more well outlets adapted to return heated impure water from the geothermal well(s);
one or more well outlets being adapted to direct the heated impure water from the geothermal well through a steam engine providing a mechanical output;
a purification plant comprising one or more purification chambers for separating impurities from the heated impure water expelled from the steam engine to produce at least some fresh water;
one or more discharge outlets to discharge one or more products of the purification plant;
wherein the fresh water is directed to an electrolyser for electrolysis to produce hydrogen gas, where the hydrogen gas is passed through a hydrogen compressor coupled to the mechanical output and pressurised in a storage apparatus.

2. The system of claim 1, wherein the geothermal well inlet and the geothermal well outlet are coupled in a single geothermal well.

3. The system of claim 1, wherein the impure water is salt water.

4. The system of claim 3, wherein the purification plant is a desalination plant.

5. The system of claim 1, wherein flow of the impure water in the system is sustained by a thermal syphoning effect of the geothermal well, drawing impure water into an inlet of the geothermal well(s) at a first temperature as heated impure water is forced out of a well outlet of the geothermal well(s) at a second temperature, greater than the first temperature.

6. The system of claim 1, wherein the one or more discharge outlets comprise at least one fresh water outlet to discharge the fresh water.

7. The system of claim 4, further comprising a saline return for a saline output from the desalination plant, and the one or more discharge outlets comprise a salt water discharge to return the saline output to a salt water source.

8. The system of claim 7, further comprising a heat exchanger to heat the salt water from the salt water intake and cool the discharge products from the purification plant, prior to discharge of the saline output to the salt water source.

9. The system of claim 1, further comprising a start-up pump to initiate flow of the salt water through the geothermal hydrogen production and compression system.

10. The system of claim 9, wherein the start-up pump is a hydrogen powered pump.

11. The system of claim 10, wherein the hydrogen powered pump is powered by a hydrogen fuel cell.

12. The system of claim 1, wherein the system is an onshore geothermal hydrogen production and compression system.

13. The system of claim 1, wherein the system is an offshore geothermal hydrogen production and compression system.

14. The system of claim 1, wherein the at least one of the geothermal well(s) reaches surrounding geology of between 300 and 425 degrees Celsius.

15. The system of claim 1, wherein the temperature of the heated impure water exiting the geothermal well is between 250 and 350 degrees Celsius.

16. The system of claim 1, wherein at least one of the geothermal well(s) reaches surrounding geology of greater than 300 degrees Celsius.

17. The system of claim 1, wherein the temperature of the heated impure water is between 120 and 190 degrees Celsius when it enters the steam engine.

18. The system of claim 1, wherein the steam engine's mechanical output is supplemented with a heat recovery turbine.

19. The system of claim 1, wherein the temperature of the heated impure water is between 50 and 120 degrees Celsius when it enters the first of the one or more desalination chambers.

20. The system of claim 1, further comprising a power plant to generate electricity from thermal energy of the heated impure water.

21. The system of claim 1, further comprising electrolysis apparatus, to separate hydrogen from oxygen in the fresh water.

22. The system of claim 1, wherein the system is pump free other than optionally a start-up pump.
